(19) United States
(12) Patent Application Publication
(10) Pub. No.: US 2023/0212836 A1
(43) Pub. Date: Jul. 6, 2023

(54) HYDRAULIC BREAKER CHISEL

(71) Applicant: MAPP CO., LTD., Ulsan (KR)

(72) Inventor: Mun Gyo JEONG, Ulsan (KR)

(73) Assignee: MAPP CO., LTD., Ulsan (KR)

(21) Appl. No.: 17/927,713

(22) PCT Filed: Nov. 5, 2021
(86) PCT No.: PCT/KR2021/015967

§ 371 Date: Nov. 24, 2022

(30) Foreign Application Priority Data
Feb. 8, 2021 (KR) 10-2021-0017463
Jun. 23, 2021 (KR) 10-2021-0081496

(51) Int. Cl. E02F 3/96; E01C 23/12

(52) U.S. Cl. CPC E02F 3/966; E01C 23/124

(57) ABSTRACT

The present invention provides a chisel for a hydraulic breaker that is installed inside the hydraulic breaker and struck by a reciprocating piston, including a chisel body having a shaft structure provided with a horn-shaped crushing portion at a lower end; and a stress distribution portion that is provided with a concave-convex form in which a plurality of grooves and protrusions are alternately formed on an outer circumferential surface of the chisel body in a longitudinal direction, and disperses a stress wave transmitted from an upper side to a lower side of the chisel body by striking of the piston and a stress wave transmitted from the lower portion to the upper portion of the chisel body by striking of a crushing portion to a crushed object.

### TECHNICAL FIELD

The present invention relates to a chisel for a hydraulic breaker that reduces vibration and an impact repulsive force generated in a process of being struck through a piston of a hydraulic breaker mounted on an excavator.

### BACKGROUND

In general, a hydraulic breaker is a device that is installed in a construction machine such as an excavator or a loader to crush rock, concrete, and the like and when a cylinder is operated, a piston moves up and down and strikes a chisel which is a crushing tool, and the chisel applies an impact force to concrete, rock, and the like, and crushes them.

Noise generated when the crushing operation is performed by using the hydraulic breaker is divided into a striking noise generated when the piston strikes the chisel and a crushing noise generated when the chisel crushes concrete and rock. Most of these are the striking noise, and a numeral value thereof varies depending on the size of the hydraulic breaker and is approximately 90 to 110 dB.

Recently, as regulations on noise and vibration have been strengthened, a noise level indication of the construction machine has been changed from a notification system to a mandatory system, and products such as an excavator, a bulldozer, loaders, and a breaker have been designated as obligatory noise level indication targets. In order to cope with these noise and vibration regulations, the development of a low noise type breaker is being actively carried out.

In particular, related organizations are also encouraging the development of the low noise type breaker, such as certifying the low noise breaker for the breaker that satisfies the noise regulations.

A conventional hydraulic breaker 1 with reference to FIG. 1 includes a hydraulic cylinder 10, a piston 20 installed to be movable up and down inside the hydraulic cylinder 10, a front head 30 coupled to a lower portion of the hydraulic cylinder 10, and a chisel 40 that is installed on the front head 30 and struck by the piston 20. A gas chamber 12 is provided at the upper end of the hydraulic cylinder 10, a valve 14 is formed on a side of the hydraulic cylinder 10, and an accumulator 50 that temporarily stores hydraulic oil for using as a kinetic energy source is formed in a lower side adjacent to the valve 14. In addition, the chisel 40 is supported by an upper bush 60 provided inside the middle of the front head 30 and a lower bush 70 coupled to a lower end of the front head 30. Further, an insertion groove (not illustrated) is formed inside the lower bush 70, and a vibration-proof material (not illustrated) may be installed in the insertion groove.

The chisel 40 is struck by the piston 20 and vibrates itself while transferring the kinetic energy of the piston 20 to a crushed object. That is, when the piston 20 lowers and strikes an upper end surface of the chisel 40, a stress wave accompanying elastic compression deformation is generated on the striking surface of the chisel 40 by the impact energy of the piston 20, and the stress wave is transmitted to the lower end along a body of the chisel 40 and finally reaches a contact surface with the crushed object, thereby performing the crushing operation.

At this time, if the piston 20 and the chisel 40 collide on a straight line, the compressive stress wave is transmitted along a center line of the chisel 40 so that vibration of the chisel 40 in a left-right or lateral direction does not occur. However, in an actual case, the respective center lines do not coincide, and the chisel 40 is eccentrically struck when striking with a gap between the chisel 40, the upper bush 60, and the lower bush 70. Therefore, a center of the contact surface between the piston 20 and the chisel 40 is formed at a point deviating from the center line of the chisel 40, so that bending deformation of the chisel 40 is generated by the impact force generated at this time. Accordingly, the chisel 40 is deformed as well as the stress wave transmitted along the chisel 40 is in a form of the compressive stress wave accompanied by the bending stress. At this time, a process is repeated in which a part of the stress wave reaching an interface with the crushed object is diffused and absorbed into the crushed object, and the remaining part thereof is reflected back and transmitted toward the striking surface with the piston 20, and then returns in a reverse direction. In this process, the stress waves are overlapped at a point where two stress waves propagating in different directions meet, and an amplitude thereof becomes conspicuous at a specific frequency by such overlap, and thereby there is a problem in that vibration and noise are generated as well as the service life of the chisel 40 is reduced.

Such a technology related to the hydraulic breaker is presented in Korean Patent Registration No. 10-1712553 (Feb. 27, 2017).

### SUMMARY OF INVENTION

### Technical Problem

An object of the present invention is to provide a chisel for a hydraulic breaker that reduces vibration and noise generated in a process of striking by a piston and crushing a crushed object.

### Solution to Problem

The present invention provides a chisel for a hydraulic breaker that is installed inside the hydraulic breaker and struck by a reciprocating piston, including a chisel body having a shaft structure provided with a horn-shaped crushing portion at a lower end; and a stress distribution portion that is provided with a concave-convex form in which a plurality of grooves and protrusions are alternately formed on an outer circumferential surface of the chisel body in a longitudinal direction, and disperses a stress wave transmitted from an upper side to a lower side of the chisel body by striking of the piston and a stress wave transmitted from the lower portion to the upper portion of the chisel body by striking of a crushing portion to a crushed object.

In addition, a plurality of the stress distribution portions may be provided to be spaced apart from each other in the longitudinal direction of the chisel body.

In addition, in the grooves and the protrusions of the stress distribution portion, the grooves may be provided such that except for a groove disposed on the uppermost side of the chisel body, the remaining grooves are formed to be sequentially deepened in depth inward the chisel body from the lower side to the upper side of the chisel body.

In addition, in the grooves and the protrusions of the stress distribution portion, thicknesses of the protrusions may be sequentially increased from the lower side to the upper side of the chisel body.

In addition, an outer circumferential surface of the chisel body located between the lowermost side of the stress distribution portion and the upper side of the crushing portion may be formed to have a tapered shape so as to decrease in diameter from the upper side to the lower side.

In addition, the chisel for a hydraulic breaker may further include an elastic absorption ring in a circular ring shape having elasticity which is inserted into each of the grooves of the stress distribution portion and absorbs vibration moving in an axial direction of the chisel body.

In addition, a plurality of cut-out grooves may be formed on the outer circumferential surface of the protrusion of the stress distribution portion to be spaced apart from each other at regular intervals in a circumferential direction.

In addition, a stress distribution hole extending inward of the chisel body may be further formed in the groove of the stress distribution portion, and a plurality of the stress distribution holes may be formed to be spaced apart from each other around the groove of the stress distribution portion.

In addition, the chisel for a hydraulic breaker may further include a vibration absorbing connection portion that is provided in the chisel body to connect the plurality of stress distribution holes, and has elasticity to absorb the vibration moving along the chisel body.

In addition, the vibration absorbing connection portion may include a plurality of insertion members that are inserted to correspond to the stress distribution holes and made of an elastic material, and a connection member having a ring shape that connects the plurality of insertion members in a state of being inserted into the outside of the chisel body.

### Advantageous Effects

The chisel for a hydraulic breaker according to the present invention is provided with the stress distribution portion of the concave-convex form in which the plurality of grooves and protrusions are formed to be alternately spaced apart from each other at regular intervals on the outer circumferential surface of the chisel body in the longitudinal direction. Therefore, the stress wave transmitted from the upper side to the lower side of the chisel body by the striking of the piston, and the stress wave transmitted from the lower side to the upper side of the chisel body by striking of the crushing portion to the crushed object are dispersed and moved in various directions when passing through the grooves and the protrusions. Thus, the overlap of the stress waves on the chisel body is minimized, and it is possible to reduce vibration and noise generated while striking the upper end of the chisel body by the piston and then striking the crushed object by the crushing portion.

### BRIEF DESCRIPTION OF THE DRAWINGS

FIG. 1 is a schematic structural sectional view of a conventional hydraulic breaker.

FIG. 2 is a perspective view of a chisel for a hydraulic breaker according to an embodiment of the present invention.

FIG. 3 is a front view of the chisel for a hydraulic breaker according to an embodiment of the present invention.

FIG. 4 is a partially enlarged sectional view of a chisel for a hydraulic breaker according to another embodiment of the present invention.

FIGS. 5 to 7 are partially enlarged perspective views of a chisel for a hydraulic breaker according to further another embodiment of the present invention.

FIG. 8 is a partially enlarged sectional view of a chisel for a hydraulic breaker according to further another embodiment of the present invention.

FIG. 9 is a simulation image illustrating a stress state when striking a crushed object of the chisel for a hydraulic breaker according to further another embodiment of the present invention and a conventional chisel for a hydraulic breaker.

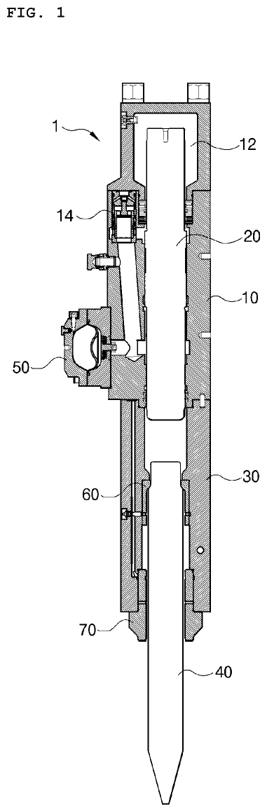

### BEST MODE FOR INVENTION

Hereinafter, preferred embodiments of the present invention will be described in detail with reference to the accompanying drawings.

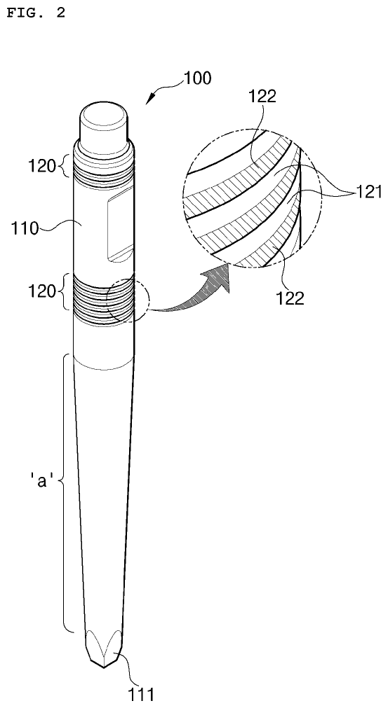

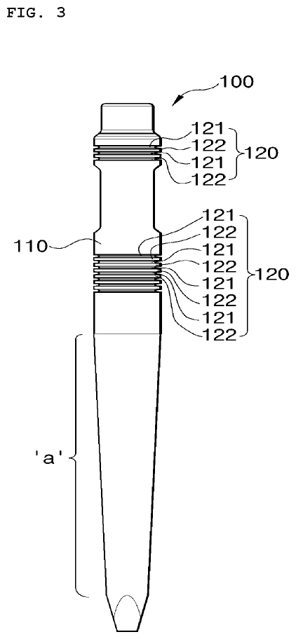

FIG. 2 is a perspective view of a chisel for a hydraulic breaker according to an embodiment of the present invention, FIG. 3 is a front view of the chisel for a hydraulic breaker according to an embodiment of the present invention. Referring to FIGS. 2 and 3, a chisel 100 for a hydraulic breaker according to an embodiment includes a chisel body 110 and a stress distribution portion 120. Here, the chisel 100 for a hydraulic breaker is struck by a piston that reciprocates by a hydraulic pressure inside a cylinder and then operates to crush a crushed object while moving. At this time, the hydraulic breaker is formed of the same configuration as that of the prior art, and a detailed description of the specific configuration of the hydraulic breaker is omitted here.

The chisel body 110 is a portion having a shaft structure struck by the piston reciprocating in a vertical direction by the hydraulic pressure. A horn-shaped crushing portion 111 is provided at a lower end of the chisel body 110 so as to crush the crushed object when colliding with the crushed object while moving downward by the piston. In this case, the crushing portion 111 may be formed in a cone or pyramid shape.

Here, an outer circumferential surface portion ‘a’ of the chisel body 110 located above the crushing portion 111 of the chisel body 110, more specifically, between the lowermost side of the stress distribution portion 120 and the upper side of the crushing portion 111 may be formed to have a tapered shape so as to decrease in diameter from the upper side to the lower side. In this way, in a case where the portion of the chisel body 110 located between the lowermost side of the stress distribution portion 120 and the upper side of the crushing portion 111 is tapered so as to decrease in diameter from the upper side to the lower side, after the crushing portion 111 collides with the crushed object, a direction of a stress wave transmitted from the lower side to the upper side of the chisel body 110 and a direction of a stress wave transmitted from the upper side to the lower side of the chisel body 110 are different from each other. Therefore, by minimizing the overlap of the stress waves, occurrence of vibration is reduced.

In addition, a tubular compression elastic body (not illustrated) with both ends open may be inserted into an outer surface of the ‘a’ portion located between the lowermost side of the stress distribution portion 120 and the upper side of the crushing portion 111 of the chisel body 110. Such a compression elastic body may be formed of soft rubber or synthetic resin having elasticity, which is compressed when the lower side of the piston strikes the upper side of the chisel body 110 while coming into contact with the chisel body 110 by moving the piston downward by hydraulic pressure, and then elastically restored to its original state after a certain period of time has elapsed. Such a compression elastic body absorbs the vibration of the chisel body 110 to cause the striking stress to be transmitted in a straight line direction parallel to an axial direction of the chisel body 110. That is, when the chisel body 110 is struck by the downward movement of the piston by hydraulic pressure, the compression elastic body is compressed toward the inner center of the chisel body 110 through an inertial force to transmit the compression force to the chisel body 110 and absorb the vibration of the chisel body 110 therethrough. In this way, the compression elastic body absorbs the vibration generated in the chisel body 110 when the chisel body 110 is struck by the piston, and the impact stress is transmitted in the straight line direction parallel to the axial direction of the chisel body 110. Therefore, the striking force of the crushing portion 111 against the crushed object increases. In this way, in a case where the compression elastic body is inserted into the chisel body 110, holding stoppers (not illustrated) may be formed to protrude at an upper end edge and a lower end edge of the ‘a’ portion on the outer circumferential surface of the chisel body 110 to hold the compression elastic body so as not to be separated from the ‘a’ portion.

In addition, the compression elastic body is elastically restored to its original state when a certain period of time has elapsed in the compressed state, that is, when a magnitude of the inertial force generated by the strike of the piston becomes smaller than a magnitude of the elastic restoring force of the compression elastic body itself. Thereafter, the compression elastic body is reduced to a compressed state by the inertial force for the vibration transmitted from the lower end to the upper end while striking the crushed object by the chisel body 110. As such, the compression elastic body reduces the vibration transmitted from the lower end to the upper end of the chisel body 110 while the lower end of the chisel body 110 strikes the crushed object. Therefore, a gap between the outer surface of the chisel body 110 and an inner wall of the hydraulic breaker is stably maintained thereby preventing damage due to contact between the outer surface of the chisel body 110 and the inner wall of the hydraulic breaker. In addition, a stable striking force is generated while a position where the chisel body 110 is struck by the piston again is maintained at a correct position.

In addition, the inner circumferential surface of the compression elastic body is formed to have a shape corresponding to the ‘a’ portion of the outer surface of the chisel body 110. That is, the inner circumferential surface of the compressive elastic body may be formed to be tapered so as to decrease in diameter from the upper side to the lower side so as to be inserted in a close contact state corresponding to the outer surface of the ‘a’ portion located between the lowermost side of the stress distribution portion 120 and the upper side of the crushing portion 111.

The stress distribution portion 120 is a portion that disperses the stress wave transmitted from the upper side to the lower side of the chisel body 110 by the strike of the piston and the stress wave transmitted from the lower side to the upper side of the chisel body 110 by the strike of the crushing portion 111 to the crushed object, thereby preventing overlap of the stress waves propagating in different directions, and reducing vibration and noise. The stress distribution portion 120 is provided in a concave-convex form in which a plurality of grooves 121 and protrusions 122 are sequentially formed alternately in the longitudinal direction on the outer circumferential surface of the chisel body 110 so as to disperse the stress waves propagating in different directions. As described above, the stress distribution portion 120 is provided in the concave-convex form in which the plurality of grooves 121 and protrusions 122 are sequentially formed alternately in the longitudinal direction on the outer circumferential surface of the chisel body 110. Therefore, the stress waves propagating along the surface of the chisel body 110 are dispersed, and the protrusions 122 convert the stress waves into the kinetic energy that fluctuates in the vertical direction, thereby minimizing the overlap of the stress waves propagating in different directions.

In addition, a plurality of the stress distribution portions 120 may be provided to be spaced apart from each other in the longitudinal direction of the chisel body 110 to increase the dispersing efficiency of the stress waves propagating in different directions. That is, in a case where the plurality of stress distribution portions 120 are provided to be spaced apart from each other in the longitudinal direction of the chisel body 110, the dispersion of the stress wave transmitted from the upper side to the lower side of the chisel body 110 by the strike of the piston and the dispersion of the stress wave transmitted from the lower side to the upper side of the chisel body 110 by the strike of the crushing portion 111 to the crushed object are made several times, thereby further reducing the overlap ratio of the stress waves, and increasing the reduction efficiency of vibration and noise.

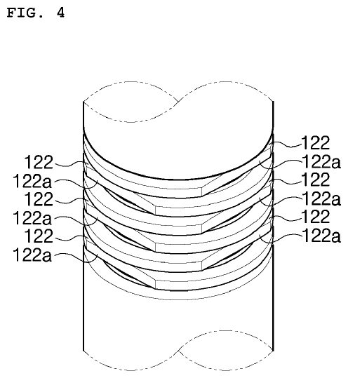

Referring to FIG. 4, in the grooves 121 of the stress distribution portion 120, except for a groove 121a disposed on the uppermost side of the chisel body 110, remaining grooves 121b may be formed to be sequentially deepened in depth from the lower side to the upper side of the chisel body 110. In this case, a depth of the groove 121a disposed on the uppermost side of the chisel body 110 may be the same as a depth of the groove 121b disposed on the lowermost side of the chisel body 110 or may be formed shallower than that of the groove 121b.

As described above, when forming the grooves 121 of the stress distribution portion 120, in a case where the remaining grooves 121b except for the groove 121a disposed on the uppermost side of the chisel body 110 are formed to be sequentially deepened in depth from the lower side to the upper side of the chisel body 110, the compressive force induced by the downward bending motion due to the inertia of the projections 122 when the chisel body 110 is lowered by the strike of the piston is stably transmitted to the lower end of the chisel body 110, and thereby the force striking the crushed object is increased. In addition, when the crushed object is struck by the crushing portion 111 which is the lower end of the chisel body 110, the vibration transmitted through the lower end of the chisel body 110 is evenly distributed and transmitted through the stress distribution portion 120. Therefore, it is possible to prevent the concentration of the stress in the grooves 121 and the projections 122 of the stress distribution portion 120.

In more detail, in the portion of the stress distribution portion 120 in which the grooves 121b are formed to be sequentially deepened in depth inward the chisel body 110 from the lower side to the upper side of the chisel body 110, when the piston strikes the upper end of the chisel body 110 inside the cylinder, the bending motion of the protrusion 122 of the stress distribution portion 120 disposed on the lower side of the chisel body 110 is first generated before the bending motion of the protrusion disposed on the upper side of the chisel body 110. At this time, the magnitude of bending the kinetic energy and compression energy of the projection 122 disposed on the upper side of the chisel body 110 is smaller than the magnitude of the bending the kinetic energy and compression energy of the projection 122 disposed on the lower side of the chisel body 110, but the bending the kinetic energy and compression energy of the protrusion 122 are concentrated in the central direction of the chisel body 110, and thereby the compression force is stably transmitted in the direction of the crushing portion 111, and the striking force against the crushed object through the stress distribution portion 120 is increased. In addition, the overlap of the vibration generated in the direction of the upper end of the chisel body 110 in the crushing portion 111 and the vibration generated in the direction of the crushing portion 111 in the upper end of the chisel body 110, through the portion of the stress distribution portion 120 in which the grooves 121b are formed to be sequentially deepened in depth inward the chisel body 110 from the lower side to the upper side of the chisel body 110, is offset thereby reducing noise generation.

In addition, when the remaining grooves 121b except for the groove 121a disposed on the uppermost side of the chisel body 110 are formed to be sequentially deepened in depth inward the chisel body 110 from the lower side to the upper side of the chisel body 110, the thickness of the protrusions 122 is sequentially increased from the lower side to the upper side of the chisel body 110, thereby improving the durability while minimizing the bending motion displacement of the protrusion 122.

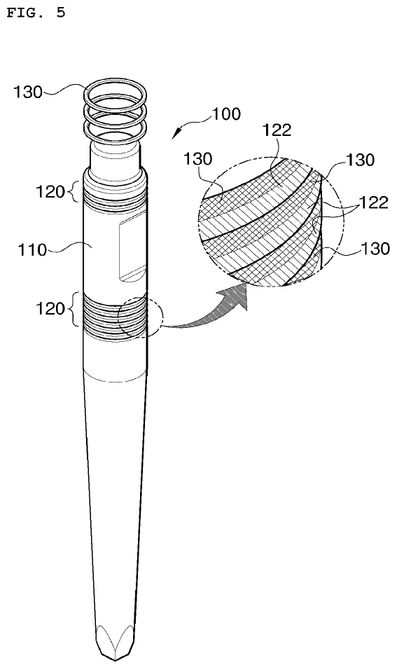

Referring to FIG. 5, a plurality of cut-out grooves 122a may be formed on the outer circumferential surface of the protrusion 122 of the stress distribution portion 120 to be spaced apart from each other at regular intervals in the circumferential direction. In addition, the cut-out grooves 122a may be formed to be alternately disposed at the same position on the plurality of protrusions 122 in the longitudinal direction of the chisel body 110. That is, the cut-out grooves 122a may be formed to be disposed at the same position on the plurality of projections 122 disposed at odd-numbered positions in the longitudinal direction of the chisel body 110, and may be formed to be disposed at the same position on the plurality of projections 122 disposed at even-numbered positions. Therefore, the protrusions 122 adjacent to each other are bending-deformed in the vertical direction due to the stress wave transmitted from the upper side to the lower side of the chisel body 110 by striking of the piston and the stress wave transmitted from the lower side to the upper side of the chisel body 110 by striking of the crushing portion 111 to the crushed object, it is possible to prevent the occurrence of interference such as collision of the protrusions 122 each other.

The protrusions 122 reduce vibration and noise while converting the stress wave transmitted from the upper side to the lower side of the chisel body 110 by striking of the piston and the stress wave transmitted from the lower side to the upper side of the chisel body 110 by striking of the crushing portion 111 to the crushed object into the kinetic energy through bending deformation of the protrusions 122 in the vertical direction. Here, although the cut-out groove 122a is illustrated as being formed in a straight cross-sectional shape on the protrusion 122 of the stress distribution portion 120, the present invention is not limited thereto and may be formed in various cross-sectional shapes other than a semi-circular cross-sectional shape.

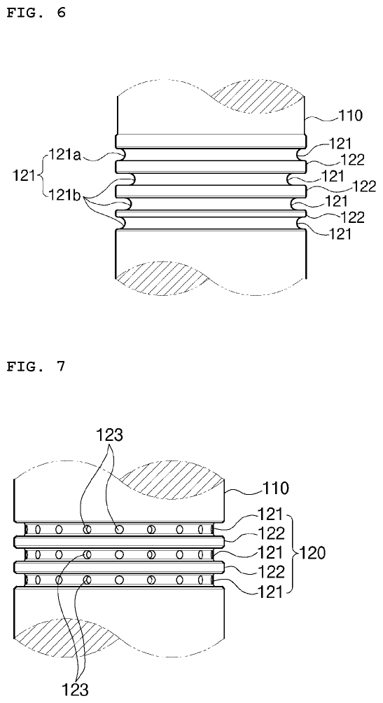

In addition, referring to FIG. 6, an elastic absorption ring 130 having elasticity may be inserted into the groove 121 of the stress distribution portion 120. The elastic absorption ring 130 may be made of a hard or soft elastic material, and may be formed in a circular ring shape to be inserted into the groove 121 of the stress distribution portion 120 so as to be disposed on the outside of the chisel body 110. In this case, one side of the elastic absorption ring 130 is provided with an open portion connecting the inner and outer sides, and when the elastic absorption ring 130 is inserted into the groove 121 of the stress distribution portion 120 so as to be disposed on the outside of the chisel body 110, a force is applied thereto so that an inner diameter increases.

In this way, in a case where the elastic absorption ring 130 is inserted into the groove 121 of the stress distribution portion 120, the strength of the groove 121 in the stress distribution portion 120 of the chisel body 110 is reinforced. In addition, when the protrusions 122 of the stress distribution portion 120 are bending-deformed in the vertical direction due to the stress wave transmitted from the upper side to the lower side of the chisel body 110 by striking of the piston and the stress wave transmitted from the lower side to the upper side of the chisel body 110 by striking of the crushing portion 111 to the crushed object, the elastic absorption ring 130 acts to reduce vibration and noise while absorbing the kinetic energy transmitted from the protrusions 122. Here, the outer circumferential surface of the elastic absorption ring 130 is formed to have a concave-convex structure, so that the kinetic energy transmitted from the protrusion 122 to be and absorbed is dispersed to increase the durability of the elastic absorption ring 130.

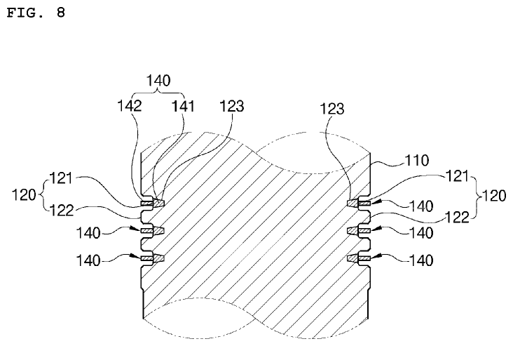

Referring to FIG. 7, a stress distribution hole 123 extending inward of the chisel body 110 may be formed in the groove 121 of the stress distribution portion 120. The stress distribution hole 123 disperses the vibration moving in the upper direction of the chisel body 110 in the crushing portion 111 in various directions on the chisel body 110 to increase the dispersion rate while reducing vibration and noise. In addition, a plurality of the stress distribution holes 123 may be formed to be spaced apart from each other in the circumferential direction of the outer circumferential surface of the chisel body 110, that is, around the portion in which the groove 121 is formed.

In addition, the stress distribution hole 123 may be formed to have a smaller diameter from the outside to the inside of the chisel body 110 so as to minimize the reduction in strength of the chisel body 110 toward the inside of the chisel body 110. In this case, the stress distribution hole 123 is formed such that the diameter becomes smaller toward the inside of the chisel body 110, and the stress distribution hole 123 is preferably formed in a tapered cross-sectional shape, but is not limited thereto, and may be formed in a multi-stage shape in which the diameter becomes smaller toward the inner side of the chisel body 110. In addition, of course, the stress distribution hole 123 may be formed to extend from the outside to the inside of the chisel body 110 in a state having the same diameter.

In addition, referring to FIG. 8, the chisel body 110 may include a vibration absorbing connection portion 140 to connect the plurality of stress distribution holes 123. The vibration absorbing connection portion 140 is formed of a material having elasticity to absorb the vibration moving along the longitudinal direction of the chisel body 110, reinforce the strength of the chisel body 110 in which the stress distribution hole 123 is formed, and to prevent the collision of the protrusion 122 adjacent to each other in the vertical direction when the protrusions 122 of the stress distribution portion 120 bend in the vertical direction. Here, the vibration absorbing connection portion 140 includes an insertion member 141 and a connection member 142.

A plurality of insertion members 141 are provided, and are portions inserted to respectively correspond to the stress distribution holes 123. Of course, the insertion member 141 is made of a material having elasticity, and more specifically, may be made of a rubber material or a synthetic resin material having ductility, but is not limited thereto, and may be made of a hard plastic material.

The connection member 142 is a ring-shaped member disposed to be inserted into the outside of the chisel body 110 in a state of connecting the plurality of insertion members 141. In this way, the connection members 142 connect the plurality of insertion members 141 to convert the bending motion in the vertical direction into the kinetic energy through the vibration transmitted through the insertion member 141, absorb the kinetic energy while colliding with the protrusions 122 during the bending motion of the protrusion 122 of the stress distribution portion 120 adjacent to each other in the vertical direction, and prevent collision of the protrusions 122 adjacent to each other in the vertical direction. Of course, the connection member 142 is made of a material having elasticity like that of the insertion member 141 described above, and more specifically, may be made of a rubber material or a synthetic resin material having ductility, but is not limited thereto, and may made of a hard plastic material.

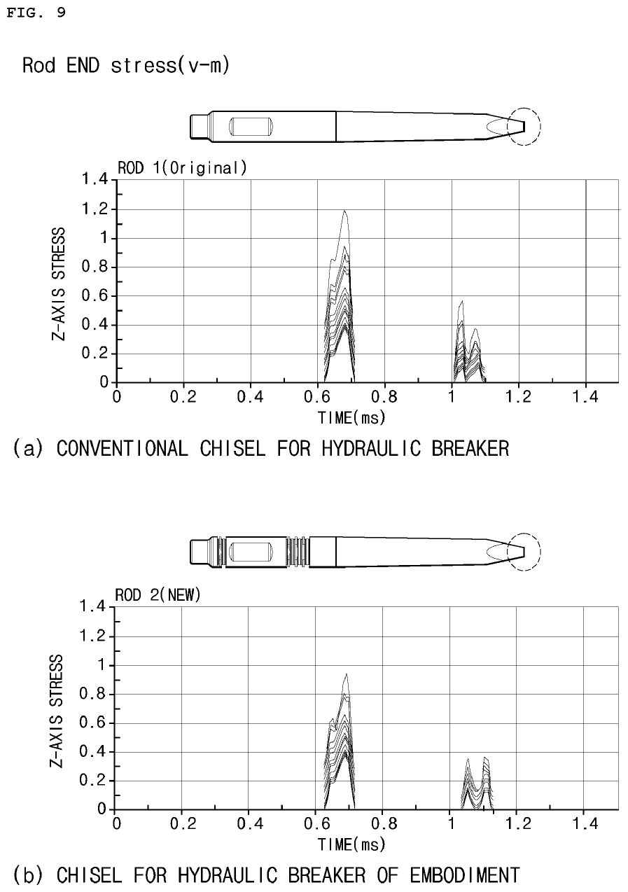

FIG. 9 is a simulation image comparing the stress state when striking the crushed object by the chisel 100 for a hydraulic breaker according to an embodiment and the conventional chisel for a hydraulic breaker, in which the piston moving downward by hydraulic pressure strikes the chisel 100 and the chisel 100 strikes a striking plate (iron plate) having a thickness of 500 t. As illustrated in FIGS. 9 (a) and (b), it can be seen that the duration of the compressive stress generated while the chisel 100 for a hydraulic breaker according to an embodiment strikes the striking plate is increased by about 15% compared to the duration of the compressive stress generated while the conventional chisel strikes the striking plate. This means that the contact time between the chisel 100 and the striking plate is increased by 15% compared to the contact time between the conventional chisel and the striking plate. As described above, as the contact time between the chisel 100 and the striking plate increases, vibration and noise generated from the chisel 100 are reduced.

As described above, an absorption operation of the vibrations generated, when striking by the piston of the chisel for a hydraulic breaker according to an embodiment configured as described above and striking of the crushed object are performed, will be described as follows.

First, when the piston moves downward by the hydraulic pressure, the lower end of the piston strikes the upper end of the chisel body 110.

At this time, the stress wave from the upper side to the lower side of the chisel body 110, that is, from one end to the other end of the chisel body 110 in the longitudinal direction causes the projection 122 to the downward bending motion due to inertia, and then allows the compressive force to be stably transmitted to the lower end of the chisel body 110 so that the striking force to the crushed object through the crushing portion 111 is increased.

In addition, while the crushing portion 111 at the bottom of the chisel body 110 strikes the crushed object, the stress wave from the lower side to the upper side of the chisel body 110, that is, from the other end to one end of the chisel body 110 in the longitudinal direction is converted into the kinetic energy through the distribution by the grooves 121 and the protrusions 122 of the stress distribution portion 120, and the bending motion of the protrusions 122 in the vertical direction.

As described above, when the piston strikes the upper end of the chisel body 110, the stress wave transmitted from the upper side to the lower side of the chisel body 110 and the stress wave transmitted from the lower side to the upper side of the chisel body 110 by striking of the crushing portion 111 to the crushed object are dispersed with each other by the grooves 121 and the protrusions 122 of the stress distribution portion 120 to minimize the overlap of the stress waves on the chisel body 110. Therefore, it is possible to reduce vibration and noise generated while striking the upper end of the chisel body 110 by the piston and then striking the crushed object by the crushing portion 111. In addition, the stress wave directed from the upper side to the lower side of the chisel body 110 causes the downward bending motion of the protrusions 122 of the stress distribution portion 120 due to inertia, and the compressive force is transmitted to the lower side of the chisel body 110, accordingly. The force of striking the crushed object by the crushing portion 111 is increased.

As described above, the chisel for a hydraulic breaker of one embodiment is provided with the stress distribution portion 120 of the concave-convex form in which the plurality of grooves 121 and protrusions 122 are formed to be alternately spaced apart from each other at regular intervals on the outer circumferential surface of the chisel body 110 in the longitudinal direction. The stress wave transmitted from the upper side to the lower side of the chisel body 110 by the striking of the piston, and the stress wave transmitted from the lower side to the upper side of the chisel body 110 by striking of the crushing portion 111 to the crushed object are dispersed and moved in various directions when passing through the grooves 121 and the protrusions 122. Therefore, the overlap of the stress waves on the chisel body 110 is minimized, and it is possible to reduce vibration and noise generated while striking the upper end of the chisel body 110 by the piston and then striking the crushed object by the crushing portion 111.

Although the present invention has been described with reference to the embodiments illustrated in the drawings, which are merely exemplary, those skilled in the art will understand that various modifications and equivalent other embodiments are possible therefrom. Accordingly, the true technical protection scope of the present invention should be defined by the technical spirit of the appended claims.

1. A chisel for a hydraulic breaker that is installed inside the hydraulic breaker and struck by a reciprocating piston, comprising:
a chisel body having a shaft structure provided with a horn-shaped crushing portion at a lower end; and
a stress distribution portion that is provided with a concave-convex form in which a plurality of grooves and protrusions are alternately formed on an outer circumferential surface of the chisel body in a longitudinal direction, and disperses a stress wave transmitted from an upper side to a lower side of the chisel body by striking of the piston and a stress wave transmitted from the lower portion to the upper portion of the chisel body by striking of a crushing portion to a crushed object.

2. The chisel for a hydraulic breaker according to claim 1,
wherein a plurality of the stress distribution portions are provided to be spaced apart from each other in the longitudinal direction of the chisel body.

3. The chisel for a hydraulic breaker according to claim 1,
wherein, in the grooves and the protrusions of the stress distribution portion, the grooves are provided such that except for a groove disposed on the uppermost side of the chisel body, the remaining grooves are formed to be sequentially deepened in depth inward the chisel body from the lower side to the upper side of the chisel body.

4. The chisel for a hydraulic breaker according to claim 3,
wherein in the grooves and the protrusions of the stress distribution portion, thicknesses of the protrusions are sequentially increased from the lower side to the upper side of the chisel body.

5. The chisel for a hydraulic breaker according to claim 1,
wherein an outer circumferential surface of the chisel body located between the lowermost side of the stress distribution portion and the upper side of the crushing portion is formed to have a tapered shape so as to decrease in diameter from the upper side to the lower side.

6. The chisel for a hydraulic breaker according to claim 1, further comprising:
an elastic absorption ring in a circular ring shape having elasticity which is inserted into each of the grooves of the stress distribution portion and absorbs vibration moving in an axial direction of the chisel body.

7. The chisel for a hydraulic breaker according to claim 1,
wherein a plurality of cut-out grooves are formed on the outer circumferential surface of the protrusion of the stress distribution portion to be spaced apart from each other at regular intervals in a circumferential direction.

8. The chisel for a hydraulic breaker according to claim 1,
wherein a stress distribution hole extending inward of the chisel body is further formed in the groove of the stress distribution portion, and
wherein a plurality of the stress distribution holes are formed to be spaced apart from each other around the groove of the stress distribution portion.

9. The chisel for a hydraulic breaker according to claim 8, further comprising:
a vibration absorbing connection portion that is provided in the chisel body to connect the plurality of stress distribution holes, and has elasticity to absorb the vibration moving along the chisel body.

10. The chisel for a hydraulic breaker according to claim 9,
wherein the vibration absorbing connection portion includes
a plurality of insertion members that are inserted to correspond to the stress distribution holes and made of an elastic material, and
a connection member having a ring shape that connects the plurality of insertion members in a state of being inserted into the outside of the chisel body.
